(19) United States
(12) Patent Application Publication
(10) Pub. No.: US 2006/0112257 A1
(43) Pub. Date: May 25, 2006

(54) Microprocessor architected state signature analysis

(76) Inventors: Stephen R. Undy, Fort Collins, CO (US); Donald C. Soltis JR., Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/987,857

(22) Filed: Nov. 12, 2004

(51) Int. Cl. G06F 15/00

(52) U.S. Cl. 712/1

(57) ABSTRACT

Techniques are disclosed for generating signatures representing modifications to architected state in a microprocessor. A plurality of signals representing a plurality of architected states of a goal microprocessor may be combined to produce a goal architected state signature of the goal microprocessor. The goal microprocessor may be actual or simulated and the plurality of architected states may be actual or simulated states. A plurality of signals representing a plurality of architected states of a test microprocessor may be combined to produce a test architected state signature of the test microprocessor. The goal signature may be compared to the test signature to determine whether the test microprocessor is faulty.

### BACKGROUND

1. Field of the Invention

The present invention relates to integrated circuit testing and, more particularly, to techniques for testing microprocessors.

2. Related Art

Electronic components, such as microprocessors and other integrated circuits, undergo significant testing during both the design and manufacturing stages. Fabricating and testing hardware prototypes of a microprocessor is expensive and time-consuming. As a result, software tools have been developed for validating and verifying the correctness of a software model of the microprocessor. Such testing enables at least some design errors to be detected and corrected without the need to fabricate and test hardware prototypes, thereby reducing overall design cost.

Typically, a software model of a microprocessor describes the microprocessor in a register transfer language (RTL). To test the software model, a set of test instructions, referred to as a “test case,” is written in the machine language of the microprocessor, and a simulator simulates the execution of those instructions by the microprocessor. Software verification tools compare the results obtained from the simulation with the results that should be obtained if the microprocessor is functioning correctly. If the expected results do not match the actual results, an error exists in the design. In response, the software model may be modified in an attempt to rectify the identified error.

It may be difficult or impossible to detect certain design errors merely by examining the outputs produced by the simulated microprocessor at the end of a simulation. As a result, some software verification tools operate concurrently with the simulator, observing changes in the internal micro-architectural state of the microprocessor and making assertions on that state while the simulator is running. Using this approach, errors in the microprocessor design that do not propagate to the external pins of the microprocessor may be discovered. For the reasons described above, typically it is less expensive and time-consuming to identify and correct such errors in the pre-fabrication software model of the microprocessor than it is to do so using a hardware prototype.

Such software simulation and verification tools, however, cannot be used once the microprocessor has been fabricated. In this post-silicon design phase, microprocessor prototypes, rather than software models, are physically tested. Furthermore, the number of tests performed in the post-silicon phase typically exceed the number performed in the pre-silicon phase by several orders of magnitude. In the post-silicon phase, however, it typically is not possible to observe the intermediate internal state of the microprocessor in the same degree of detail as in the pre-silicon phase. In fact, in many cases the intermediate internal state of the microprocessor may not be observable at all during post-silicon testing. Rather, it may only be possible to observe the final external state of the microprocessor prototype after a test case has been run on it. Such testing, therefore, has the disadvantage that it may fail to detect intermediate internal errors that do not propagate to the external pins of the microprocessor.

A read-only scan latch (ROSL) is an example of circuitry that has been used to observe and store the state of a circuit under test (CUT), such as a microprocessor. A ROSL may be coupled to the input and/or output of the circuit to store the state of the input and/or output at a particular clock cycle triggered by some test circuitry, and subsequently read through a scan chain shift operation. Because each ROSL stores a single bit of data, typically a large number of ROSLs are coupled to a circuit to store as many bits as are desired to be observed. If a group of ROSLs, for example, is coupled to the outputs of a circuit, the output values stored in the group of ROSLs may be read upon the completion of a test and compared to the expected output values. A ROSL in its simplest form does not provide a history of the values produced at the outputs of the circuit during the test.

A “signature ROSL,” in contrast, may be used to observe not only the final state of a circuit at the end of a test, but also the intermediate state of the circuit at various points during the test. Before describing the operation of conventional signature ROSLs, the concept of a “signature” will be described by reference to the prior art system 100 illustrated in FIG. 1A. The system 100 includes a software model 102 of the circuit design. The circuit model 102 may, for example, be a model of a particular implementation of a microprocessor. The system 100 also includes a test case 104, which includes a set of instructions (inputs) to be provided (in simulation) to the circuit modeled by the circuit model 102 (referred to herein as the “modeled circuit”).

A circuit simulator 106 receives the circuit model 102 and test case 104 as inputs, and simulates the execution of the test case 104 by the modeled circuit. The simulation produces a test response 108, which represents one or more simulated states of the modeled circuit during the simulation. The test response 108 may, for example, include a plurality of states of the modeled circuit, representing the outputs of the modeled circuit at each successive simulated clock cycle during the simulation.

A goal signature generator 110 compresses the test response 108 to produce a signature 112, referred to as a “goal signature.” In particular, the goal signature generator 110 includes a running signature 114 that may be initialized to a default value, such as zero. When the signature generator 110 receives the next set of state information in the test response 108, a signature function 116 in the signature generator 110 combines the test response state information with the current value of the running signature 114 to produce a new value for the running signature 114. The signature function 116 replaces the old value of the running signature 114 with the new value. The signature function 116 may, for example, be an XOR function. The signature generator 110 thereby updates the value of the running signature 114 with the state information for each successive state of the modeled circuit. The final value of the running signature 114 (i.e., after the signature function 116 incorporates the final state information from the test response 108 into the running signature 114) is provided as a goal signature 112.

The goal signature 112 may subsequently be used to validate the operation of hardware prototypes implementing the circuit model 102. For example, referring to FIG. 1B, a prior art system 120 is shown for using the goal signature 112 to validate the operation of a circuit under test 122 (such as a microprocessor) that is designed to implement the circuit model 102. The same test case 104 that was used to generate the goal signature 112 is provided to the circuit under test 122.

The system 120 also includes a signature ROSL 126, which is coupled to the circuit under test 122. Although only the single signature ROSL 126 is shown in FIG. 1B for ease of illustration, the signature ROSL 126 may be a multi-bit signature ROSL, which includes a plurality of one-bit signature ROSLs, and which is therefore capable of generating a multi-bit signature based on multiple bits in the test response 124 to be measured. Assume, for purposes of example, that the test response 124 to be measured includes the outputs of the circuit under test 122 after each clock cycle.

At each clock cycle, the signature ROSL 126 reads the corresponding portion of the test response 124 (e.g., the corresponding output bit) from the circuit under test 122. The signature ROSL 126 includes a running signature 130 that may be initialized to a default value, such as zero. When the next state value is latched into the signature ROSL 126 from the test response 124, a test signature generator 128 in the signature ROSL 126 combines the state value with the current value of the running signature 130 to produce a new value for the running signature 130. The test signature generator 128 replaces the old value of the running signature 130 with the new value through a latch 132. The signature generator 128 generates new values of the running signature 130 using the same function (e.g., XOR) as the signature function 116 shown in FIG. 1A. The signature ROSL 126 thereby updates the value of the running signature 130 with the state information obtained at each successive clock cycle from the test response 124.

The signature ROSL 126 provides the final value of the running signature 130 as a test signature 134. If the circuit under test 122 has been correctly implemented in accordance with the circuit model 102 and the circuit under test 122 operated correctly when executing the test case 104, the test signature 134 would be the same as the goal signature 112 generated in FIG. 1A. Therefore, the system 120 includes a comparator 136 which compares the goal signature 112 to the test signature 134 and produces a valid signal 138 which indicates whether the two signatures 112 and 134 are equal to each other. The valid signal 138 may be provided to error detection/correction circuitry (not shown) for taking appropriate corrective action if the test signature 134 is not equal to the goal signature 112.

Because the goal signature 112 and test signature 134 capture information about intermediate states of the circuit model 102 and circuit under test 122, respectively, the techniques described above with respect to FIGS. 1A-1B may be used to detect errors in circuit fabrication that would not be detectable if only final states were observed and compared to each other.

Although in the examples above, signature ROSLs are described as capturing the external state of the circuit under test 122, signature ROSLs may also be coupled to internal nodes of the circuit under test 122 to observe the internal state of the circuit 122 while the test case 104 is being executed. When signature ROSLs are used to observe the internal state of the circuit 122, however, the test signature 134 may, in some circumstances, fail to match the goal signature 112 even though the circuit 122 has executed the test case 104 correctly. If the circuit under test 122 is a microprocessor, for example, the circuit under test 122 may implement the circuit model 102 accurately and yet differ from the circuit model 102 in certain implementation details which cause the test signature 134 to differ from the goal signature 112.

As a result, signature ROSLs typically have been limited in use to generating goal signatures for the internal state of a single implementation of a circuit. In other words, the goal signature 112 typically may only be used to test one implementation of the circuit model 102. To test another implementation of the same circuit model 102, it has been necessary to generate another goal signature. Such a process is inefficient and prone to error, since one goal signature may inadvertently be used with the wrong circuit implementation, thereby causing the comparator 136 to indicate falsely that the circuit under test 122 is faulty, thereby causing unnecessary inspection and/or modification of the circuit under test 122 and/or the circuit model 112.

What is needed, therefore, are improved techniques for testing integrated circuit designs.

### SUMMARY

Techniques are disclosed for generating signatures representing modifications to architected state in a microprocessor. A plurality of signals representing a plurality of architected states of a goal microprocessor may be combined to produce a goal architected state signature of the goal microprocessor. The goal microprocessor may be actual or simulated and the plurality of architected states may be actual or simulated states. A plurality of signals representing a plurality of architected states of a test microprocessor may be combined to produce a test architected state signature of the test microprocessor. The goal signature may be compared to the test signature to determine whether the test microprocessor is faulty.

In one aspect of the present invention, a method is provided which includes steps of: (A) providing a first plurality of signals as input to an architectural simulator which simulates operation of a first microprocessor when provided with the first plurality of signals as input to produce a second plurality of signals representing a first plurality of architected states of the first microprocessor; (B) combining the second plurality of signals to produce a goal architected state signature; (C) providing a third plurality of signals as inputs to a second actual microprocessor to produce a fourth plurality of signals representing a second plurality of architected states of the second microprocessor; (D) combining the fourth plurality of signals to produce a test architected state signature; (E) determining whether the test architected state signature is equivalent to the goal architected state signature; and (E) generating a signal indicating whether the goal architected state signature is equivalent to the test architected state signature.

Other features and advantages of various aspects and embodiments of the present invention will become apparent from the following description and from the claims.

### BRIEF DESCRIPTION OF THE DRAWINGS

FIG. 1A is a diagram of a prior art system for generating a goal signature for use in testing a circuit;

FIG. 1B is a diagram of a prior art system for using the goal signature generated in FIG. 1 to test a circuit;

FIG. 2 is a flowchart of a method for testing a microprocessor according to one embodiment of the present invention;

FIGS. 3A-3B are diagrams of systems which may be used to perform the method of FIG. 2; and

FIG. 4 is a diagram of a microprocessor in which architected state changes are captured to produce an architected state signature according to one embodiment of the present invention.

### DETAILED DESCRIPTION

Techniques are disclosed for generating signatures representing modifications to architected state in a microprocessor. A plurality of signals representing a plurality of architected states of a goal microprocessor may be combined to produce a goal architected state signature of the goal microprocessor. The goal microprocessor may be actual or simulated and the plurality of architected states may be actual or simulated states. A plurality of signals representing a plurality of architected states of a test microprocessor may be combined to produce a test architected state signature of the test microprocessor. The goal signature may be compared to the test signature to determine whether the test microprocessor is faulty.

The “architectural state” (or “architected state”) of a microprocessor refers to that subset of the state of the microprocessor that is operated upon by the instruction set of the processor. The architected state of a microprocessor is therefore also referred to as the instruction set architecture (ISA) of the microprocessor. The architectural state of a microprocessor may, for example, include the state of the microprocessor's registers and memory.

Architectural state typically does not include the state of implementation-dependent features of the microprocessor. Such state is referred to as “microarchitectural state.” Microarchitectural state may include, for example, the state of individual transistors or logic gates within the microprocessor. Another example of microarchitectural state is the branch prediction history stored in the microprocessor. Once an instruction set architecture of a microprocessor has been defined, the instruction set architecture may be implemented in a variety of different microprocessor designs, so long as such design behaves in accordance with the instruction set architecture. Different microprocessor implementations having the same instruction set architecture may differ in their microarchitectural features and, therefore, in their microarchitectural states while executing the same instruction stream.

The instruction set architecture of the Intel® Itanium® Processor Family (IPF) microprocessor architecture, for example, is defined in Chapter 3 (“Execution Environment”) of Volume 1 of the “Intel® Itanium® Architecture Software Developer's Manual,” Revision 2.1, published October 2002 by Intel Corporation, and hereby incorporated by reference. In particular, the IPF instruction set architecture defines how the states of processor registers and memory change when particular instructions are executed.

The IPF instruction set architecture defines the following registers:

General Registers (GRs). These are general purpose 64-bit registers, labeled GR0-GR127.

Floating-point Registers (FRs). These are floating point registers, labeled FR0-FR127.

Predicate Registers (PRs). These are single-bit registers used in predication and branching, and are labeled PR0-PR63.

Branch Registers (BRs). These registers are used in branching and are labeled BR0-BR7.

Instruction Pointer (IP). This register holds the bundle address of the currently-executing instruction.

Current Frame Marker (CFM). This register holds the state that describes the current general register stack frame and FR/PR rotation.

Application Registers (ARs). These are a collection of special-purpose registers.

Performance Monitor Data Registers (PMD). These are data registers for performance monitoring hardware.

User Mask (UM). This is a set of single-bit values used for alignment traps, performance monitors, and to monitor floating-point register usage.

Processor Identifiers (CPUID). These registers describe processor implementation-dependent features.

These registers are defined in more detail in Section 3.1 of the above-referenced Software Developer's Manual. The state of such registers is part of the architectural state of any IPF processor, and therefore is accessible to application programs executing on any IPF microprocessor. The IPF architecture and the particular set of registers described above are provided herein merely as examples and do not constitute limitations of the present invention. Rather, techniques disclosed herein may be used in conjunction with various processor architectures having various registers.

As mentioned above, the state (contents) of memory may be included in the architectural state of a processor. For example, Part I, Sections 3.2, 4, and 10.6 of the above-referenced Software Developer's Manual describe the IPF memory model. The memory that is included within an instruction set architecture may include, for example, main memory, cache memory, or both furthermore, even if cache memory forms part of the architectural state of a microprocessor, certain features of cache state, such as the “private” or “invalid” status of cache entries, may be excluded from architectural state.

The execution of an instruction in the instruction set of a microprocessor causes changes to be made to the architectural state of the microprocessor in defined ways. For example, arithmetic instructions, such as instructions for performing addition and subtraction, modify the state of the register or memory location in which the result of the arithmetic instruction is stored. Consider, for example, an add instruction, such as r5=r6+r7, which adds the contents of registers r6 and r7 and stores the results in register r5. This change to the state of register r5 is an example of an architectural state update, because the state of register r5 is part of the architectural state of the microprocessor.

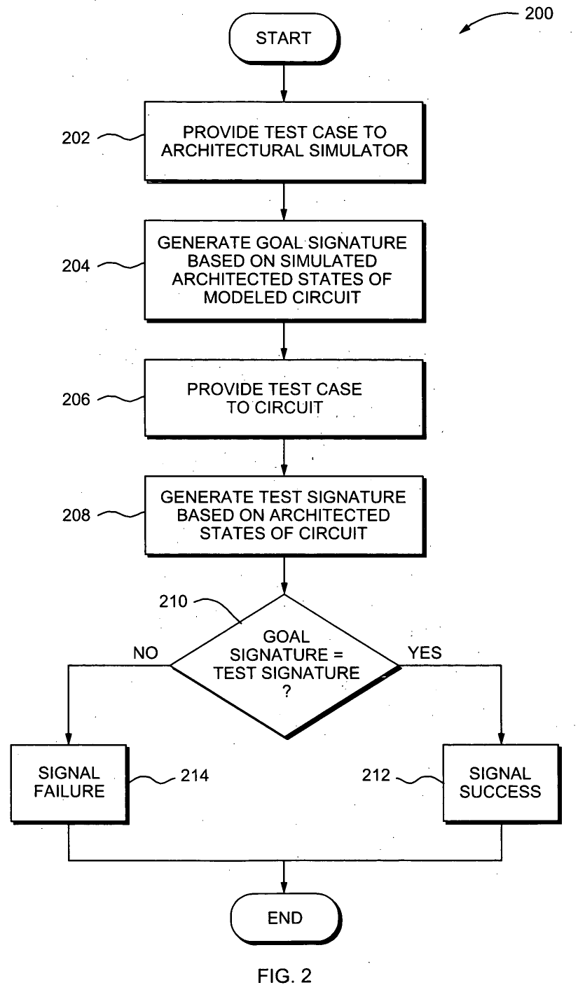

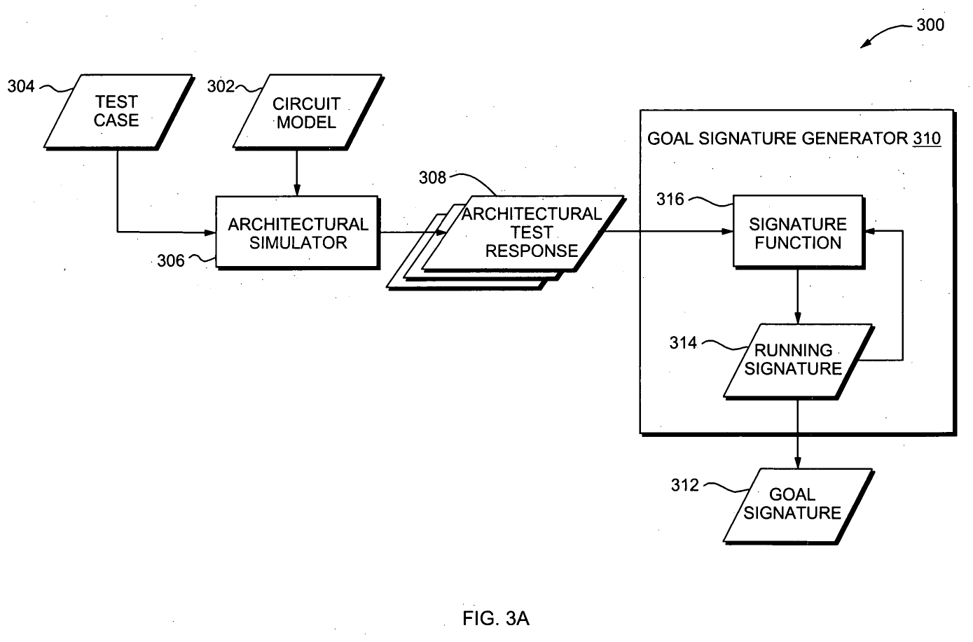

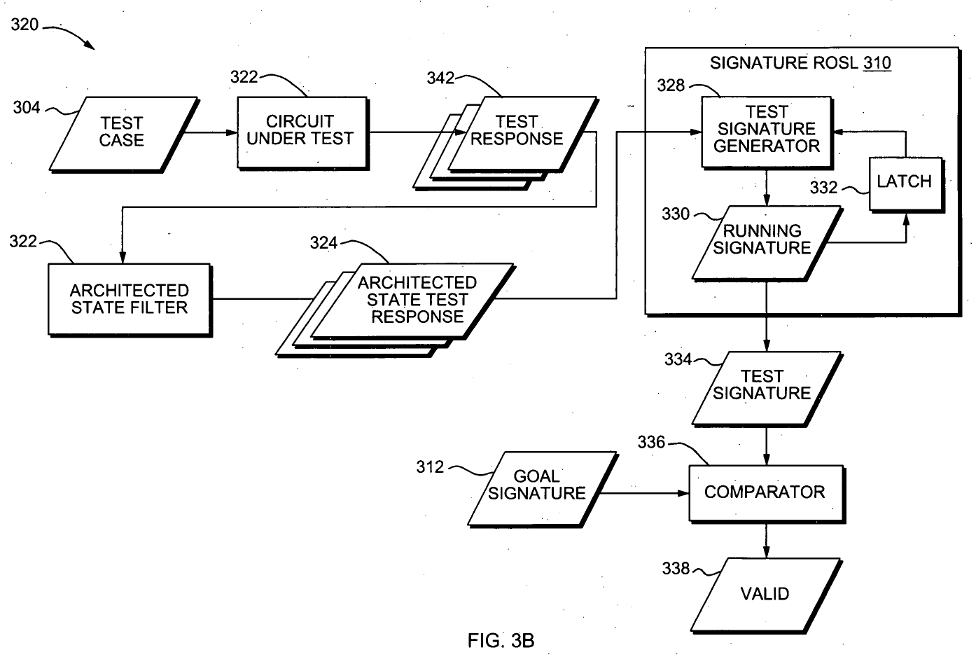

In one embodiment of the present invention, a microprocessor is tested by generating a test signature based on the architected state of the microprocessor, and by comparing the test signature to a goal signature generated based on the goal architected state of the microprocessor. For example, referring to FIG. 2, a flowchart is shown of a method 200 that is performed in one embodiment of the present invention to test a microprocessor according to one embodiment of the present invention. Referring to FIGS. 3A-3B, diagrams are shown of systems 300 and 320 which may be used to perform the method 200 shown in FIG. 2.

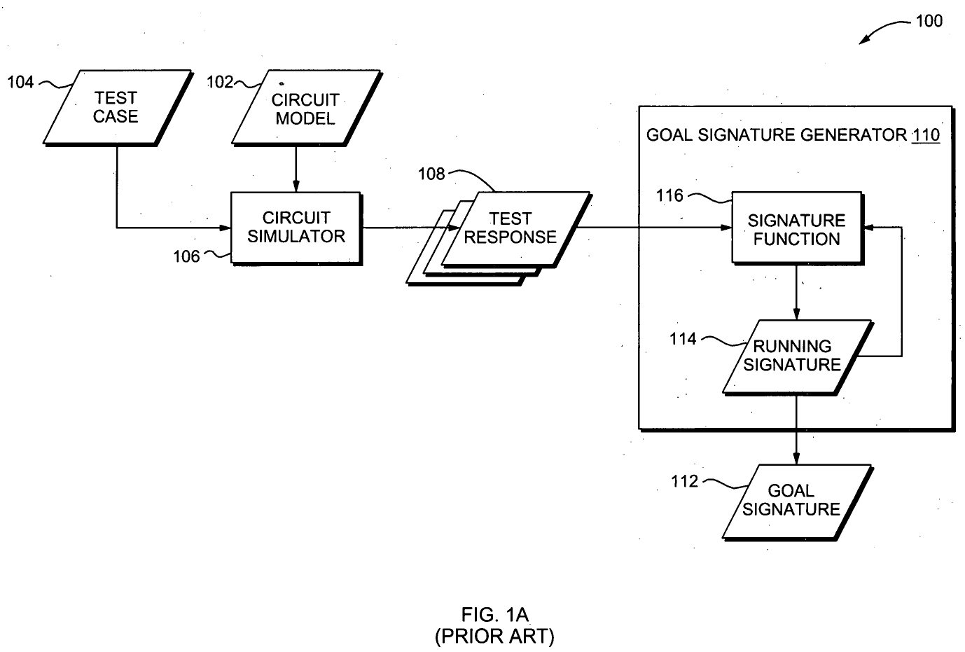

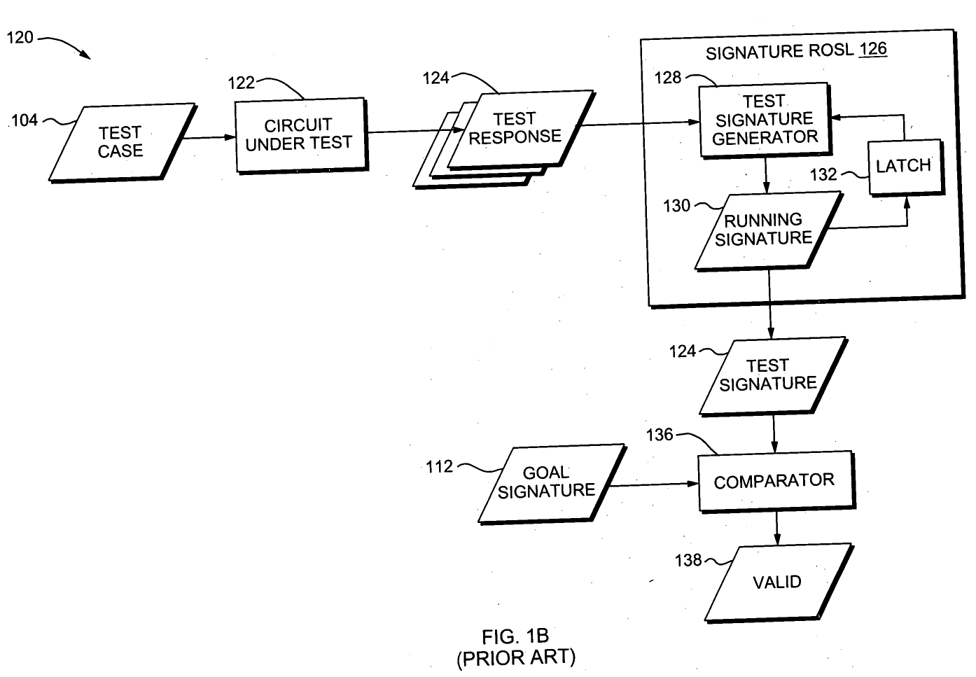

System 300 includes a model 302 of a circuit such as a microprocessor, and a test case 304 including instructions suitable for execution by the circuit modeled by the model 302. The circuit model 302 and test case 304 may be implemented, for example, in the manner described above with respect to the model 102 and test case 104 shown in FIG. 1.

The system 300 also includes an architectural simulator 306. The architectural simulator 302 is a kind of simulator which behaves in accordance with the instruction set architecture. As a result, the only state changes simulated by the architectural simulator 302 are changes to the architectural state of the modeled circuit. The architectural simulator 302 does not, therefore, simulate changes to the microarchitectural state of the modeled circuit. In doing so, it operates more quickly than a microarchitectural simulator.

The method 200 provides the test case 304 to the architectural simulator 306 (step 202). In response, the architectural simulator 306 simulates the execution of the test case 304 on the modeled circuit.

The method 200 generates a goal signature 312 based solely on the simulated architectural states of the modeled circuit during simulated execution of the test case 304 on the modeled circuit (step 204). The goal signature 312 may, for example, be generated as follows. The architectural simulator 306 produces an architected test response 308 when simulating execution of the test case 304 on the circuit model 302. The architected test response 308 is similar to the test response 108 produced by the circuit simulator 106 (FIG. 1A), except that the architected state test response 324 only includes state information about architected states of the modeled circuit, such as the values of registers during the simulation.

The system 300 also includes a goal signature generator 310, which includes a signature function 316 and a running signature 314, and which may generate goal signature 312 in the same manner as the goal signature generator 110 shown in FIG. 1A generates the goal signature 112. Since the goal signature generator 310 shown in FIG. 3A, however, generates the goal signature 312 based solely upon architectural state information contained in the architectural state response 308, the goal signature 312 reflects only changes to the architectural state of the modeled circuit during simulated execution of the test case 304. The prior art goal signature 112, in contrast, reflects changes both to architectural state and to microarchitectural state.

Referring to FIG. 3B, the system 320 includes a circuit under test 322 (such as a microprocessor) which implements circuit model 302. The method 200 provides the test case 304 to the circuit under test 322 (step 206), thereby causing the circuit under test 322 to execute the instructions in the test case 304.

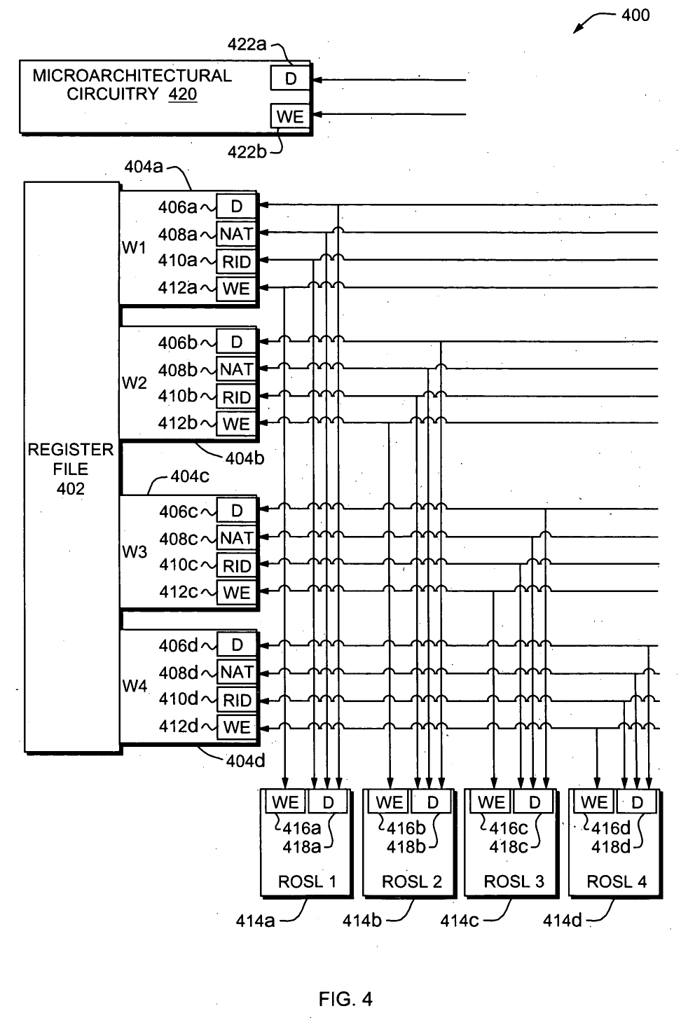

The method 200 generates a test signature 334 based solely on the architectural states of the circuit 322 during execution of the test case 304 (step 208). The method 200 may generate the test signature 334 as follows. The circuit under test 322 provides a test response 342, in the manner described above with respect to the test response 108 in FIG. 1A. The test response 342 may include information about both the architectural state and microarchitectural state of the circuit under test 322 during execution of the test case 304. The system 320 also includes an architected state filter 340, which is coupled to the circuit under test 322. The architected state filter 340 receives the test response 342 from the circuit 322 while the circuit 322 is executing the test case 304. The architected state filter 340 filters out any information about the microarchitectural state of the circuit 322 and produces an architected state test response 324, which includes state information only about architected states of the circuit 322 during execution of the test case 304. The architected state test response 324 does not, in other words, contain information about changes to the microarchitectural state of the circuit 322 during execution of the test case 304. Examples of circuitry that may be used to implement the architectural state filter 340 will be described below with respect to FIG. 4.

The system 320 also includes a signature ROSL 326, which includes a test signature generator 328 and a running signature 330 coupled to the test signature generator 328 through a latch 332, and which may generate a test signature 334 in the same manner as the signature ROSL 126 shown in FIG. 1B generates the test signature 124. Since the signature ROSL 326 shown in FIG. 3B, however, generates the test signature 334 based solely upon architectural state information contained in the architected state response 324, the test signature 334 reflects only changes to the architectural state of the circuit 322 during execution of the test case 304. The prior art test signature 124, in contrast, reflects change to both architectural state and microarchitectural state.

The method 200 determines whether the test signature 334 is equal to the goal signature 312 (step 210). If the test signature 334 is equal to the goal signature 312, the method 200 signals success (step 212); otherwise, the method 200 signals failure (step 214). Steps 210-214 may, for example, be implemented by comparator 336, which compares test signature 334 to goal signature 312 and generates a valid signal 338 which indicates whether the two signatures 312 and 334 are equal to each other.

Referring to FIG. 4, a diagram is shown of a microprocessor 400 in which architected state changes are captured to produce an architected state signature according to one embodiment of the present invention. The microprocessor 400 includes a register file 402. Although the register file 402 may include any number of registers of any kind, assume for purposes of example in the following description that the register file 402 is an IPF register file, which include 128 64-bit registers. A register file in an IPF architecture has 12 read ports, which are not shown in FIG. 4 because they are not relevant to the embodiment of the invention illustrated in FIG. 4.

A register file in an IPF architecture also includes eight write ports. Four such write ports 404a are illustrated in FIG. 4 for ease of illustration. The techniques disclosed herein may, however, be used in conjunction with any number of write ports. Write port 404a has four inputs: (1) a data input 406a for receiving a 64-bit value to be written to one of the registers in the register file 402; (2) a 1-bit “not a thing” (NaT) input 408a, which is used to indicate whether the contents of the register being written are not valid; (3) a register ID input 410a for receiving a 7-bit register ID, identifying which of the 128 registers in the register file is to be written with the data provided at the data input 406a; and (4) a 1-bit write enable input 412a, which is asserted when the data at input 406a is to be written to the register identified by the register ID at input 410a. Write ports 404b-d similarly include data inputs 406b-d, NaT inputs 408b-d, register ID inputs 410b-d, and write enable inputs 412b-d, respectively.

The particular write port inputs in FIG. 4 are shown merely for purposes of example. As will become clear from the following description, embodiments of the present invention may be used in conjunction with write ports having other kinds of inputs.

The microprocessor 400 also includes signature ROSLs 414a-d, which correspond to write ports 404a-d, respectively. ROSL 414 has a write enable input 416a, which is coupled to the write enable input 412a of corresponding write port 404a. ROSL 414a also has a data input 418a, which is coupled to data input 406a, NAT input 408a, and register ID input 410a of write port 404a. In the present example, the data input 418a is a 72-bit input (64 bits for the data at input 406a, 1 bit for the NAT signal at input 408a, and 7 bits for the register ID at input 412a of write port 404a).

Because the write enable signal provided to input 412a of write port 404a is also provided to write enable input 416a of ROSL 414a, the ROSL 414a updates the signature chain (using the 72 bits of data described above as input to the chain) when, and only when, new data is written to write port 404a. Furthermore, recall that a change to the contents of a processor register is a kind of architectural state change. Because the ROSL 414a is coupled to a register file write port, which receives new data to be stored in microprocessor registers, the ROSL 414a only receives data representing changes to architectural state. As a result, the ROSL 414a generates a signature chain (a subset of a signature) based solely on architectural state information.

Signature ROSLs 414b-d are similarly coupled to write ports 404b-d, respectively, and therefore operate in the same manner as signature ROSL 414a. More specifically, ROSL 414b records architectural state changes written to write port 404b, ROSL 414c records architectural state changes written to write port 404c, and ROSL 414d records architectural state changes written to write port 404d. The signature chains generated by signature ROSLs 414a-d may be treated in combination as a single test signature (such as the test signature 334 shown in FIG. 3B).

Microprocessor 400 also includes microarchitectural circuitry 420, illustrated in block form for ease of illustration. The microarchitectural circuitry 420 may be any circuitry which implements microarchitectural features of the microprocessor 400, such as circuitry for storing branch prediction history. Such circuitry 420 may have any number of inputs and outputs. For purposes of example, a single data input 422a and write enable input 422a are shown in FIG. 4. Note that none of the ROSLs 414a-d is coupled to the inputs 422a-b to the microarchitectural circuitry 420, thereby further illustrating that ROSLs 414a-d generate signatures based solely on architected state changes in the microprocessor 400.

Referring again to FIG. 3B, assume that the signature ROSL 310 is implemented in the manner shown in FIG. 4, in which case the combination of the signature ROSLs 414a-d perform the function of the single signature ROSL 310 shown in FIG. 3B. In this case, the architected state filter 322 is implemented by coupling ROSLs 414a-d to data inputs 406a-d, NAT inputs 408a-d, and register ID inputs 410a-d, respectively. This coupling provides only architected state change information to the ROSLs 414a-d and thereby effectively filters out information about microarchitectural state changes.

Referring again to FIG. 3B, recall that in one embodiment of the present invention, architected state change information is provided to the test signature generator 328 only when a change to architected state has occurred. This effect is achieved in the microprocessor 400 of FIG. 4 by coupling the write enable inputs 412a-d of write ports 404a-d to the write enable inputs 416a-d of ROSLs 414a-d, respectively. In such an arrangement, the signature is only updated into ROSLs 414a-d when data representing an architected state change is provided to the corresponding one of the write ports 404a-d.

Among the advantages of the invention are one or more of the following. Techniques disclosed herein may be used to generate and collect predictable signatures of architected state modification to allow increased observability of internal microprocessor state during post-silicon functional and electrical verification. In particular, the generation of goal signatures based solely on architected state enables post-silicon testing of multiple implementations of a single microprocessor architecture to be performed using a single goal signature, thereby eliminating the need to generate separate goal signatures for each implementation and thereby reducing or eliminating the likelihood that one microprocessor implementation will be falsely identified as faulty when tested with a goal signature generated using a different microprocessor implementation.

Another advantage of techniques disclosed herein is that an architectural simulator, rather than a chip simulator (also referred to as a “cycle-accurate simulator), may be used to simulate operation of the circuit to generate the goal signatures. An architectural simulator simulates only the architectural behavior of a circuit and not the more detailed and complex microarchitectural behavior. As a result, architectural simulators perform simulation much more rapidly than microarchitectural simulators, and may therefore be used to generate goal signatures much more quickly than microarchitectural simulators, thereby decreasing overall design time.

Furthermore, the circuitry required to implement techniques disclosed herein may be simpler and less expensive to implement than circuitry which monitors and records microarchitectural state modifications. Because only a subset of state changes—namely, the subset of state changes representing changes to architected state—are monitored and recorded in embodiments of the present invention, fewer ROSLs and other circuitry may be required to generate test signatures than in implementations which monitor and record microarchitectural state modifications.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although an XOR function is provided in the description above as an example of a signature function, this is merely an example and does not constitute a limitation of the present invention. It is desirable, however, that the signature function not be idempotent; i.e., it is desirable that multiple applications of the signature function not result in the same signature. More formally this may be stated as shown in Equation 1:
(A\textcircled{x}A\textcircled{x}S)≠(A\textcircled{x}S), Equation 1
where \textcircled{x} is the signature function, A is the input (architected state changes) to the signature function, and S is the accumulated (running or final) signature. The signature function may also be chosen to be non-commutative as well. More formally this may be stated as shown in Equation 2:
(A\textcircled{x}B\textcircled{x}S)≠(B\textcircled{x}A\textcircled{x}S), Equation 2
where B is an input distinct from A.

Although in the examples above the circuit under test is simulated using an architectural simulator, this is not a requirement of the present invention. Rather, the circuit model may be simulated using any kind of circuit simulator. For example, a chip simulator could be used to simulate the circuit model, in which case changes to architectural state could be selected from the output of the chip simulator to generate the goal signature.

Although an architectural state filter is shown in FIG. 3B, the techniques disclosed herein are not limited to use in conjunction with such a filter. For example, although the filter generates the architectural state response by selecting a subset of its input, the architectural state response need not be generated in this manner. Rather, the system 320 may include one or more components, such as the ROSLs 414a-d shown in FIG. 4, which are configured to receive only the changes to architectural state, in which case there would be no need for explicit filtering.

The particular examples of architected state disclosed herein are merely examples and do not constitute limitations of the present invention. For example, the state of external memory (e.g., RAM or ROM) coupled to a microprocessor may be considered to be part of the architected state of the microprocessor. Features of a memory location which may be characterized as architected state include, for example, the physical address of the memory location, the MESI (modified, exclusive, shared, invalid) state of the memory location, and the value of new data to be stored in the memory location. Those having ordinary skill in the art will appreciate how to apply the techniques disclosed herein to architected state including external memory.

Furthermore, particular kinds of state (such as the NaT signals provided at inputs 408a-d in FIG. 4) which are characterized as architectural state in the examples above may be considered to be microarchitectural state when considered in relation to other microprocessor architectures. In addition, it is not required that all architectural state changes be monitored and/or recorded. Rather, techniques disclosed herein may be used to monitor and/or record a subset of architectural state changes in a circuit.

Although it is stated in the description above that the comparator 336 compares the test signature 334 to the goal signature 312 to determine whether the two signatures 334 and 312 are equal to each other, the comparator 336 need not determine whether the signatures 334 and 312 are strictly equal. Rather, more generally, the comparator 336 may determine whether the signatures 334 and 312 are equivalent to each other in the sense that both represent the same set of architected state changes. In practice, the test signature 334 and goal signature 312 may be equivalent in this sense even though the two are not equal. The two signatures 334 and 312 may, for example, represent state information in different formats, causing them to be unequal even when they are equivalent.

As used herein, the term “simulated circuit” refers to a software model of a circuit, such as the circuit model 302 described above with respect to FIG. 3A. As used herein, the term “actual circuit” refers to a physical embodiment of a circuit, such as the circuit under test 322 described above with respect to FIG. 3B.

Although the ROSLs 414a-d in FIG. 4 are coupled to write ports 404a-d to capture architected state information, this is not a requirement of the present invention. Rather, the ROSLs 414a-d may capture architected state information by being coupled to other circuit elements in addition to or instead of write ports 404a-d. For example, ROSLs 414a-d may be coupled directly to individual registers or to groups of registers in the register file 402 to capture architected state changes to those registers or groups of registers.

What is claimed is:

1. A method comprising:
combining a first plurality of signals representing a first plurality of architected states of a first microprocessor to produce a test architected state signature; and
determining whether the test architected state signature is equivalent to a goal architected state signature representing a second plurality of architected states of a second microprocessor.

2. The method of claim 1, further comprising:
prior to combining the first plurality of signals, combining a second plurality of signals representing a second plurality of architected states of a second microprocessor to produce the goal architected state signature.

3. The method of claim 2, further comprising:
prior to combining the first plurality of signals, providing a third plurality of signals as inputs to the first microprocessor to produce the first plurality of signals; and
prior to combining the second plurality of signals, providing the third plurality of signals as inputs to the second microprocessor to produce the second plurality of signals.

4. The method of claim 3, wherein the first microprocessor comprises a simulated microprocessor and wherein combining the third plurality of signals comprises using an architectural simulator to produce the first plurality of signals.

5. The method of claim 1, further comprising: generating a signal indicating whether the goal architected state signature is equivalent to the test architected state signature.

6. The method of claim 1, wherein the first microprocessor comprises an actual microprocessor and wherein the second microprocessor comprises a simulated microprocessor.

7. The method of claim 1, wherein the first microprocessor comprises a plurality of registers, and wherein the plurality of architected states comprises a plurality of states of the plurality of registers.

8. The method of claim 1, wherein the first microprocessor is coupled to a memory including a plurality of memory locations, and wherein the plurality of architected states comprises a plurality of states of the plurality of memory locations.

9. A method comprising:
providing a first plurality of signals as input to an architectural simulator which simulates operation of a first microprocessor when provided with the first plurality of signals as input to produce a second plurality of signals representing a first plurality of architected states of the first microprocessor;
combining the second plurality of signals to produce a goal architected state signature;
providing a third plurality of signals as inputs to a second actual microprocessor to produce a fourth plurality of signals representing a second plurality of architected states of the second microprocessor;
combining the fourth plurality of signals to produce a test architected state signature;
determining whether the test architected state signature is equivalent to the goal architected state signature; and
generating a signal indicating whether the goal architected state signature is equivalent to the test architected state signature.

10. A device comprising:
means for combining a first plurality of signals representing a first plurality of architected states of a first microprocessor to produce a test architected state signature; and
means for determining whether the test architected state signature is equivalent to a goal architected state signature representing a second plurality of architected states of a second microprocessor.

11. The device of claim 10, further comprising:
means combining a second plurality of signals representing a second plurality of architected states of a second microprocessor to produce the goal architected state signature.

12. The device of claim 11, further comprising:
means for providing a third plurality of signals as inputs to the first microprocessor to produce the first plurality of signals; and
means for providing the third plurality of signals as inputs to the second microprocessor to produce the second plurality of signals.

13. The device of claim 12, wherein the first microprocessor comprises a simulated microprocessor and wherein the means for providing the third plurality of signals comprises means for using an architectural simulator to produce the first plurality of signals.

14. A microprocessor comprising:
a register file comprising a plurality of write ports, the plurality of write ports comprising a plurality of register write enable inputs and a plurality of register data inputs;
microarchitectural circuitry implementing microarchitectural features of the microprocessor;
a plurality of signature read-only scan latches (ROSLs) comprising a plurality of ROSL write enable inputs coupled to the plurality of register write enable inputs and a plurality of ROSL data inputs coupled to the plurality of register data inputs, wherein none of the plurality of ROSL write enable inputs is coupled to the microarchitectural circuitry and wherein none of the plurality of ROSL data inputs is coupled to the microarchitectural circuitry.

15. The microprocessor of claim 14, wherein the plurality of write ports further comprises a plurality of not a thing (NaT) inputs, and wherein the plurality of ROSL data inputs are further coupled to the plurality of NAT inputs.

16. The microprocessor of claim 14, wherein the plurality of write ports further comprises a plurality of register ID inputs, and wherein the plurality of ROSL data inputs are further coupled to the plurality of register ID inputs.

17. A microprocessor comprising:
a first plurality of nodes, the plurality of nodes comprising:
a second plurality of nodes implementing an architectural state of the microprocessor; and
a third plurality of nodes not implementing the architectural state of the microprocessor; and
architected state signature means, coupled to the second plurality of nodes, for generating an architected state signature based on signals at the second plurality of nodes and not on signals at the third plurality of nodes.

18. The integrated circuit of claim 17, wherein the architected state signature means comprises a plurality of read-only scan latches (ROSLs) coupled to the second plurality of nodes.

19. The microprocessor of claim 17, wherein the architected state signature means is not coupled to the third plurality of nodes.

20. The microprocessor of claim 17, further comprising a plurality of registers coupled to the second plurality of nodes.

21. The microprocessor of claim 17, wherein the second plurality of nodes is coupled to a plurality of memory locations external to the microprocessor.
